(19) United States
(12) Patent Application Publication
(10) Pub. No.: US 2013/0019843 A1
(43) Pub. Date: Jan. 24, 2013

(54) FUEL TANK APPARATUS FOR HYBRID VEHICLE

(71) Applicants: Norifumi IWAYA, Obu-shi (JP); Takayuki SANO, Okazaki-shi (JP); Yasuyuki KIMATA, Nagoya-shi (JP)

(72) Inventors: Norifumi IWAYA, Obu-shi (JP); Takayuki SANO, Okazaki-shi (JP); Yasuyuki KIMATA, Nagoya-shi (JP)

(73) Assignee: MITSUBISHI JIDOSHA KOGYO KABUSHIKI KAISHA, Tokyo (JP)

(21) Appl. No.: 13/553,190

(22) Filed: Jul. 19, 2012

(30) Foreign Application Priority Data
Jul. 20, 2011 (JP) 2011-158752
Jul. 20, 2011 (JP) 2011-158753

(51) Int. Cl. F02M 37/00

(52) U.S. Cl. 123/512; 123/511

(57) ABSTRACT

A fuel tank apparatus mounted on a hybrid vehicle being switched between an engine drive mode and an engine stop mode, includes: a fuel supply shut-off unit configured to shut off fuel supply to the engine in the engine stop state; a cup disposed inside a fuel tank body; a fuel pump configured to operate to supply fuel stored in the cup to the fuel supply pipe; and a fuel pump controlling unit configured to operate the fuel pump to perform fuel supply to the engine and to allow fuel to enter the inside of the cup in the engine drive mode, and configured to operate the fuel pump to allow fuel to enter the inside of the cup although fuel supply to the engine is shut off by the fuel supply shut-off unit, in the engine stop mode.

### BACKGROUND OF THE INVENTION

The present invention relates to a fuel tank apparatus mounted on a hybrid vehicle that can run using an engine and a motor which are driven independently of each other.

An ordinary gasoline vehicle is configured so that it runs by starting an engine and by rotating front and rear wheels. However, since the output of the engine is set under the consideration that the engine performs high-load (high-speed) operation, the energy conversion efficiency of the engine lowers significantly during low-lad (low-speed) operation. Hence, hybrid vehicles have become widely used in which electric motors are used to rotate the front and rear wheels without starting the engine during low-speed operation. Such hybrid vehicles have been widely accepted tremendously in recent years because of less amount of petroleum fuel being consumed and less amount of carbon dioxide being emitted, along with world-wide surge in petroleum fuel prices, increased awareness about the reduction of carbon dioxide, etc.

Examples of main apparatuses mounted on a hybrid vehicle are briefly shown in FIG. 6. The hybrid vehicle has an engine 14, a generator 15, an inverter 16, a front motor 17, a rear motor 18, a catalyzer 19, a high-voltage battery 20, a fuel tank 21, a muffler 22, a front power-transmission apparatus 23, a clutch 24, a rear power-transmission apparatus 25, front wheels 12, and rear wheels 13 in the vehicle body 11 thereof.

In the case of the hybrid vehicle taken herein as an example, the engine 14 and the front motor 17 are respectively connected to the front wheels 12 via the front power-transmission apparatus 23, and only the rear motor 18 is connected to the rear wheels 13 via the rear power-transmission apparatus 25.

At startup and during low-speed running, the electricity stored in the high-voltage battery 20 is converted by the inverter 16 and operates the front motor 17 and the rear motor 18, whereby the front wheels 12 and the rear wheels 13 are rotated and the vehicle runs. Since the clutch 24 inside the front power-transmission apparatus 23 is disengaged at this time, the engine 14 is disconnected and does not take part in the operation.

During ordinary running, the clutch 24 inside the front power-transmission apparatus 23 is engaged, the engine 14 is started to rotate the front wheels 12, and speed control is performed while the high-voltage battery 20 is charged by the generator 15 (hereafter, the front motor 17 and the rear motor 18 are referred to as a whole as an electric motor 17).

The engine 14 and some of apparatuses disposed therearound will be described herein briefly using FIG. 7 to facilitate the understanding of the following descriptions. First, when a fuel filler port switch 32 is pressed, a fuel filler port cap 34 installed on a fuel filler port sensor 33 is opened. Fuel 2 supplied therefrom passes through a fuel shut-off valve 35 and is stored at the bottom of the fuel tank 21. When the engine 14 is started, the fuel 2 stored in the fuel tank 21 is sucked by a fuel pump 3, passes through a pipe 10a, and is transferred from an injector 31 to the engine 14. At the time, the fuel 2 is also stored in a pump cup 1. An ECU (electronic control unit) 7 has the role of a controller for issuing control commands for the respective apparatuses.

Although the injector 31 is a fuel injection nozzle, it is configured so that the fuel 2 does not flow into the engine 14 when the engine 14 is not started. At the time, when the pressure inside the pipe 10a rises, it is configured that the fuel 2 is discharged into the pump cup 1 (the method for discharging the fuel will be described later). Furthermore, it is configured that the fuel 2 filled in and overflowing from the pump cup 1 returns into the fuel tank 21.

Since the hybrid vehicle is configured so that it can run on either the engine 14 or the electric motor 17 or run on both as described above (see FIG. 6), a case is assumed in which the vehicle runs for a long time without starting the engine 14 depending on the method of driving the vehicle. In such a case, it is likely that water is separated from the fuel 2 in the fuel tank 21 and causes rust in pipes and that an adverse effect occurs at the start time of the engine 14 due to the degradation of the fuel. To solve this problem, a method is available in which the fuel pump 3 is driven to circulate the fuel 2 inside the fuel tank 21 when the stop period of the engine 14 becomes equal to or more than a certain value (refer to Japanese Patent No. 4280870).

However, if the vehicle runs continuously without starting the engine 14, it is likely that a problem different from the above-mentioned problem occurs at shorter time intervals.

A pump cup according to a related art and some of apparatuses disposed therearound will be described using FIGS. 5, 6 and 7. First, the pump cup 1 is disposed inside the fuel tank 21, the fuel pump 3 is provided in the pump cup 1, and the pipe 10a extends from the fuel pump 3 to the engine 14. The pipe 10a is branched in the middle. In the middle of a branched pipe 10b that is branched from the pipe 10a, a regulator 6 is disposed so as to be oriented toward the pump cup 1. In the neighborhood of the fuel suction port (communication port) 1a of the pump cup 1 having a one-way valve 5, the end of the branched pipe 10b is disposed so as to face the fuel suction port 1a. The end portion of the branched pipe 10b and the fuel suction port 1a of the pump cup 1 are referred to as a whole as a filling jet pump 4. The ECU 7 has the role of a controller for issuing control commands for the fuel pump 3.

Usually, in the case that the engine 14 is started, the fuel pump 3 is driven first, whereby part of the fuel 2 inside the pump cup 1 is sucked from the fuel suction port 3a of the fuel pump 3, and the sucked fuel 2 passes through the pipe 10a and is transferred to the engine 14. At the time, the fuel 2 also flows through the branched pipe 10b that is branched from the pipe 10a. It is configured that the fuel 2 passes through the regulator 6 disposed in the middle of the branched pipe 10b and spouts from the end of the branched pipe 10b and that the fuel 2 and part of the fuel 2 inside the fuel tank 21 pass through the fuel suction port 1a of the pump cup 1 having the one-way valve 5 and are transferred to the pump cup 1. In other words, at the start time of the engine 14, the pump cup 1 is in a state of being always filled with the fuel 2 by the operation of the filling jet pump 4.

In a state in which the vehicle runs by driving the electric motor 17 without starting the engine 14, the above-mentioned operation is not performed. Even if the fuel 2 likely flows into the engine 14, the injector 31 prevents the flow as described above. Hence, even if the fuel pump 3 is driven during the stoppage of the engine 14, the fuel 2 is not transferred to the engine 14. At the time, when the pressure inside the pipe 10a rises, the regulator 6 discharges the fuel 2 to the pump cup 1. Hence, there is no danger that the pipe 10a bursts because of the pressure.

However, the fuel 2 stored in the pump cup 1 overflows sometimes from the opening in the upper portion of the pump cup 1 due to rocking during vehicle running. In particular, if significant rocking occurs during slalom running for example, a large amount of the fuel 2 overflows at a time.

When the vehicle runs by starting the engine, no problem occurs because the fuel 2 is supplied into the pump cup 1. However, when the vehicle runs using the electric motor 17, the fuel 2 is not supplied into the pump cup 1 because the fuel pump 3 and the filling jet pump 4 are stopped. Hence, the amount of the fuel 2 inside the pump cup 1 keeps on decreasing due to rocking during running. This state may occur provided that the vehicle only runs, even when neither the engine 14 nor the electric motor 17 is started, as a matter of course.

If this state continues, it is likely that the fuel 2 does not remain inside the pump cup 1 when the starting of the engine 14 is requested and that the starting becomes defective.

Furthermore, even during vehicle stoppage, if the sealing of the one-way valve 5 is incomplete, the fuel 2 inside the pump cup 1 leaks therefrom. Hence, if the vehicle stops for a long time, it is likely that a problem similar to that described above will occur.

### SUMMARY

It is therefore an aspect of the invention to provide an apparatus capable of solving the above-mentioned problem by automatically supplying fuel into a pump cup when a vehicle runs with its engine stopped.

In order to achieve this aspect, according to the invention, there is provided a fuel tank apparatus mounted on a hybrid vehicle capable of being switched between an engine drive mode in which vehicle running using an engine is performed or power generation using the engine is performed, in an engine drive state in which fuel supply to the engine is performed, and an engine stop mode in which vehicle running using an electric motor is performed or a running preparation state is maintained, in an engine stop state in which fuel supply to the engine is shut off, the fuel tank apparatus comprising: a fuel supply pipe, which extends from a fuel tank body and one end of which is connected to the engine, for fuel supply to the engine; a fuel supply shut-off unit which configured to allow fuel supply to the engine from the fuel supply pipe in the engine drive state and which configured to shut off fuel supply to the engine in the engine stop state; a cup which is disposed inside the fuel tank body and which includes a communication port which communicates with inside and outside of the cup and through which fuel is allowed to enter the cup, the cup which is configured to temporarily store fuel to be allowed to enter the fuel supply pipe; a fuel pump which is configured to operate to supply fuel stored in the cup to the fuel supply pipe and to generate negative pressure inside the cup to allow fuel to enter the inside of the cup through the communication port; and a fuel pump controlling unit which is configured to control the operation of the fuel pump, the fuel pump controlling unit which is configured to operate the fuel pump to perform fuel supply to the engine and to allow fuel to enter the inside of the cup, in the engine drive mode, the fuel pump controlling unit which is configured to operate the fuel pump to allow fuel to enter the inside of the cup although fuel supply to the engine is shut off by the fuel supply shut-off unit, in the engine stop mode.

In the engine stop mode, the fuel pump controlling unit may operate the fuel pump for a time to allow fuel to enter the inside of the cup although fuel supply to the engine is shut off by the fuel supply shut-off unit.

A one-way valve that is opened by the negative pressure generated inside the cup when the fuel pump is operated to allow fuel to enter the cup from the fuel tank body may be disposed at the communication port.

The fuel tank apparatus may further comprise a branched pipe which is branched from the fuel supply pipe to discharge fuel inside the cup to the outside of the cup from the fuel supply pipe, one end of the branched pipe outside the cup being positioned so as to face the communication port.

The fuel pump controlling unit may perform timer-based repetitive operation to operate the fuel pump repeatedly.

The fuel pump controlling unit may perform a first cycle of the timer-based repetitive operation when a power source of the hybrid vehicle is turned on in the engine stop mode and a state of the hybrid vehicle is shifted to the running preparation state.

The fuel tank apparatus may further comprise an acceleration detecting unit which is configured to detect an acceleration of the vehicle. The fuel pump controlling unit may forcibly operate the fuel pump for a time depending on the acceleration detected by the acceleration detecting unit.

The fuel tank apparatus may further comprise a liquid level detecting unit which is configured to detect a liquid level of fuel stored inside the cup. In the engine stop mode, the fuel pump controlling unit may operate the fuel pump, depending on a value of the liquid level detected by the liquid level detecting unit, to allow fuel to enter the inside of the cup although fuel supply to the engine is shut off by the fuel supply shut-off unit.

A one-way valve that is opened by the negative pressure generated inside the cup when the fuel pump is operated to allow fuel to enter the cup from the fuel tank body may be disposed at the communication port.

The fuel tank apparatus may further comprise a branched pipe which is branched from the fuel supply pipe to discharge fuel inside the cup to the outside of the cup from the fuel supply pipe, one end of the branched pipe outside the cup being positioned so as to face the communication port.

The liquid level detecting unit may include a first liquid level sensor disposed above the other end of the fuel supply pipe positioned inside the cup. The fuel pump controlling unit may operate the fuel pump when the liquid level of fuel stored inside the cup lowers to a position below the first liquid level sensor.

The liquid level detecting unit may further include a second liquid level sensor disposed above the first liquid level sensor. The fuel pump controlling unit may start the operation of the fuel pump when the liquid level of fuel stored inside the cup lowers to a position below the first liquid level sensor, continue the operation of the fuel pump until the liquid level of fuel rises to a position of the second liquid level sensor, and stop the operation of the fuel pump when the liquid level of fuel rises to a position above the first liquid level sensor.

### BRIEF DESCRIPTION OF THE DRAWINGS

FIG. 1 is a schematic view illustrating a pump cup and some of apparatuses relating thereto according to Embodiments 1 to 3 of the present invention;

FIG. 2 is a schematic view illustrating a pump cup and some of apparatuses relating thereto according to Embodiment 2 of the present invention;

FIG. 3 is a schematic view illustrating a pump cup and some of apparatuses relating thereto according to Embodiment 4 of the present invention;

FIG. 4 is a schematic view illustrating a pump cup and some of apparatuses relating thereto according to Embodiment 5 of the present invention;

FIG. 5 is a schematic view illustrating a pump cup and some of apparatuses relating thereto according to the related art;

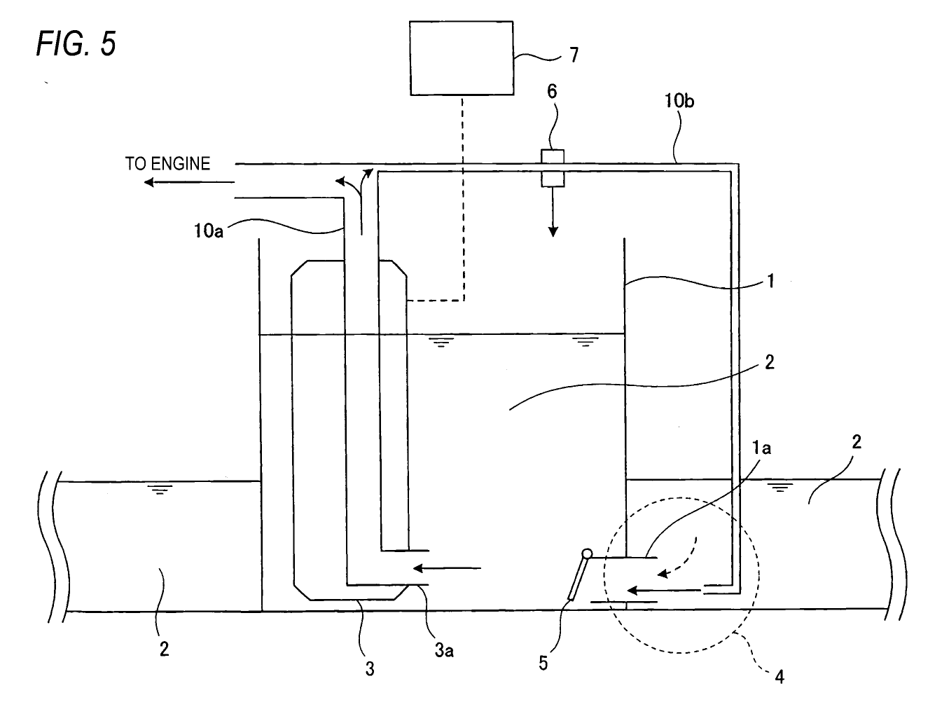

FIG. 6 is a view illustrating the layout of main apparatuses mounted on a hybrid vehicle; and

FIG. 7 is a schematic view illustrating an engine, a fuel tank, and some of apparatuses relating thereto.

### DETAILED DESCRIPTION OF EMBODIMENTS

The following will describe in detail a fuel tank apparatus mounted on a hybrid vehicle that can run using an engine and a motor driven independently of each other according to the present invention, that is, a hybrid vehicle capable of being switched between an engine drive mode in which vehicle running using the engine is performed to rotate the drive wheels thereof using the drive power of the engine or power generation using the engine is performed to generate electric power by driving a power generator using the drive power of the engine, in an engine drive state in which fuel is supplied to the engine, and an engine stop mode in which vehicle running using an electric motor is performed so that the vehicle runs using the motor or a running preparation state is maintained when the power source of the vehicle is turned on, in an engine stop state in which fuel supply to the engine is shut off, in the descriptions of embodiments with reference to the accompanying drawings.

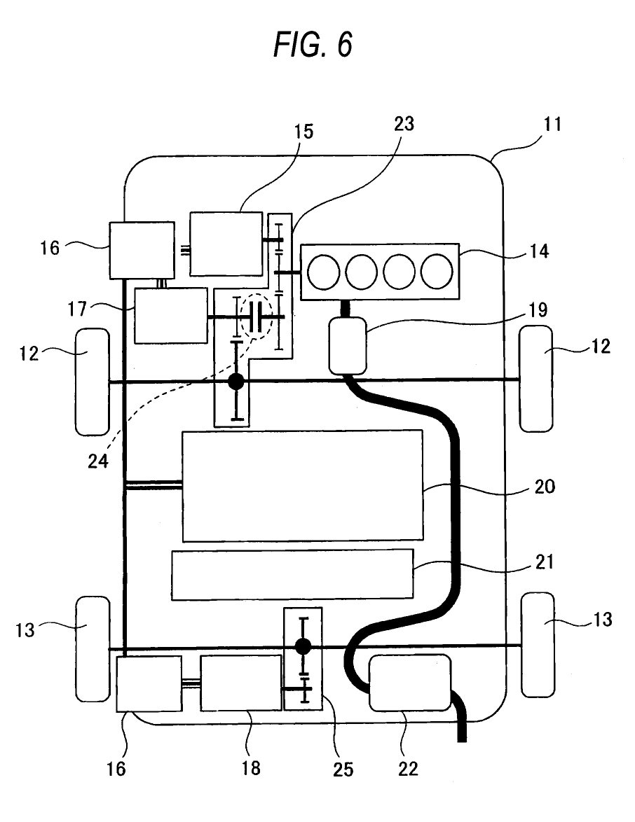

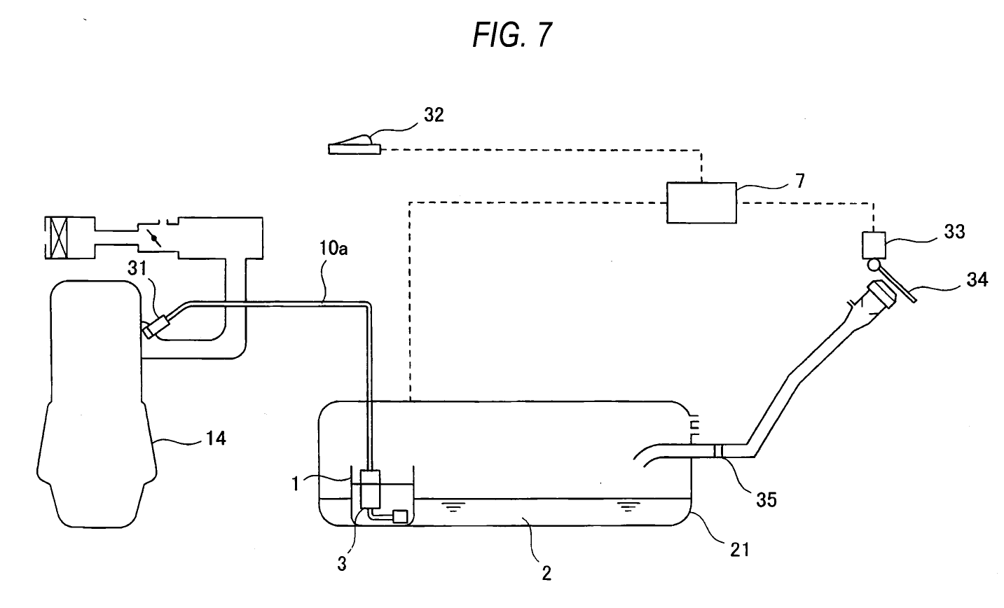

FIGS. 6 and 7 having been used for the description of the pump cup according to the related art will also been referred to in the following descriptions. The components having functions similar to those of the components shown in FIGS. 6 and 7 are designated by the same reference numerals and described.

### Embodiment 1

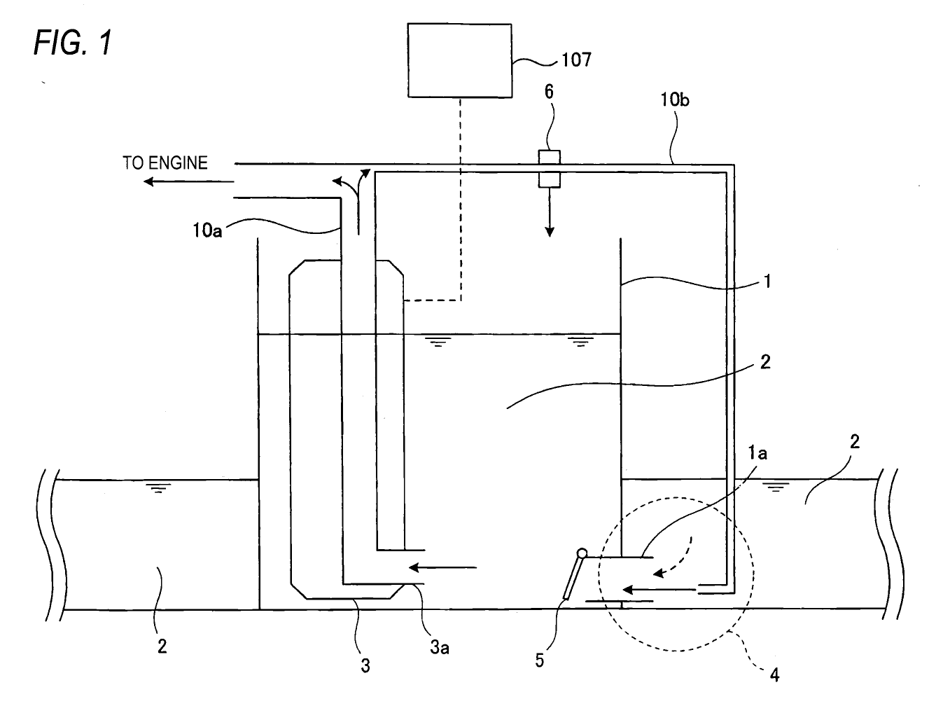

The apparatus according to Embodiment 1 of the present invention will be described using FIG. 1. A pump cup (cup) 1 is disposed inside a fuel tank 21, a fuel pump 3 is provided in the pump cup 1, and a pipe (fuel supply pipe) 10a extends from the fuel pump 3 to an engine 14. The pipe 10a is branched in the middle. In the middle of a branched pipe 10b that is branched from the pipe 10a, a regulator 6 is disposed so as to be oriented toward the pump cup 1. In the neighborhood of the fuel suction port (communication port) 1a of the pump cup 1 having a one-way valve 5, the end of the branched pipe 10b is disposed so as to face the fuel suction port 1a. The end portion of the branched pipe 10b and the fuel suction port 1a of the pump cup 1 are referred to as a whole as a filling jet pump 4. An ECU 107 (a fuel pump controlling unit) incorporating a time measurement function has the role of a controller for issuing control commands for the fuel pump 3.

When the engine 14 is started, that is, in the engine drive mode in which vehicle running using the engine is performed to rotate the drive wheels thereof using the drive power of the engine or power generation using the engine is performed to generate electric power by driving a power generator using the drive power of the engine, as in the case of the related art, the fuel pump 3 is driven first, whereby part of the fuel 2 inside the pump cup 1 is sucked from the fuel suction port 3a of the fuel pump 3, and the sucked fuel 2 passes through the pipe 10a and is transferred to the engine 14. At the time, the fuel 2 also flows through the branched pipe 10b that is branched from the pipe 10a. It is configured that the fuel 2 passes through the regulator 6 disposed in the middle of the branched pipe 10b and spouts from the end of the branched pipe 10b and that the fuel 2 and part of the fuel 2 inside the fuel tank 21 pass through the fuel suction port 1a of the pump cup 1 having the one-way valve 5 and are transferred to the pump cup 1. In other words, when the engine 14 is started, the pump cup 1 is in a state of being always filled with the fuel 2 by the operation of the filling jet pump 4. Hence, even if the fuel 2 overflows from the pump cup 1 due to rocking when the engine 14 is started and the vehicle is running, the fuel 2 is not exhausted.

The apparatus according to Embodiment 1 has a timer function for automatically driving the fuel pump 3 at constant time intervals according to the control commands of the ECU 107 incorporating the time measurement function even in the stop state of the engine 14 (engine stop mode), that is, even when vehicle running using the electric motor is performed so that the vehicle runs using the drive power of the motor or even when the vehicle stops while the running preparation state at the time when the power source of the vehicle is turned on is maintained. Since the fuel 2 is supplied to the pump cup 1, an appropriate amount of the fuel 2 is maintained inside the pump cup 1, whereby it is possible to avoid a state in which the fuel 2 is exhausted from the inside of the pump cup 1 at the start time of the engine 14.

As described already, even if the fuel 2 likely flows into the engine 14 in the stop state of the engine 14, an injector (a fuel supply shut-off unit) 31 prevents the flow. Hence, even if the fuel pump 3 is driven during the stoppage of the engine 14, the fuel 2 is not transferred to the engine 14. At the time, when the pressure inside the pipe 10a rises, the regulator 6 discharges the fuel 2 to the pump cup 1. Hence, there is no danger that the pipe 10a bursts because of the pressure.

In the apparatus according to Embodiment 1, an appropriate amount of fuel can be maintained inside the pump cup 1 by performing the above-mentioned setting.

### Embodiment 2

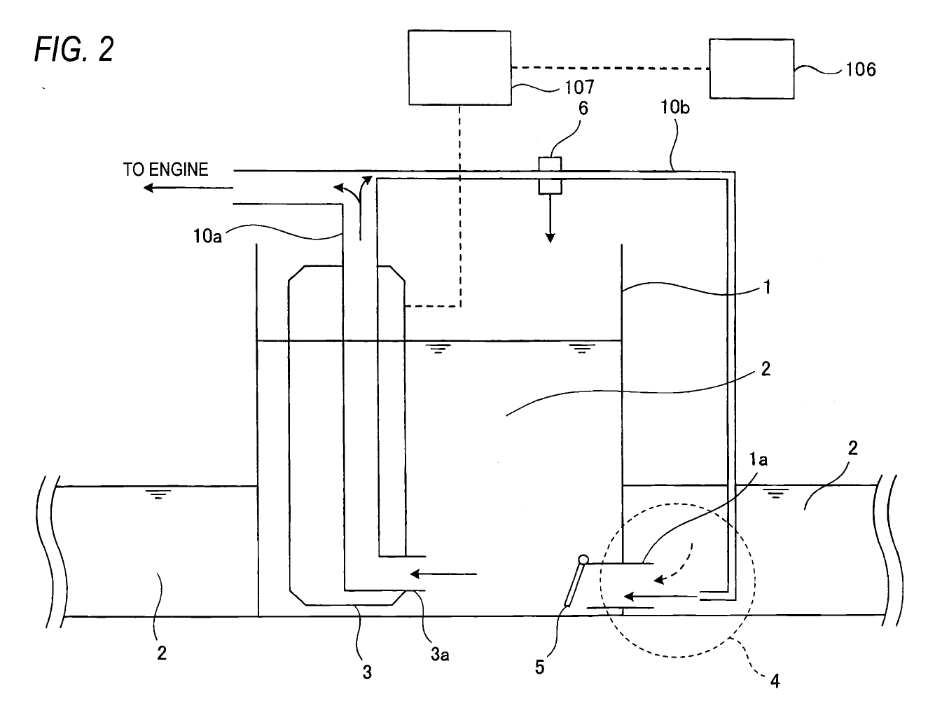

An apparatus according to Embodiment 2 of the present invention will be described using FIG. 2. In the apparatus according to Embodiment 2, an acceleration sensor (an acceleration detecting unit) 106 is added to the apparatus according to Embodiment 1. The acceleration sensor 106 is electrically connected to the ECU 107. The ECU 107 has a function of issuing a control command for automatically driving the fuel pump 3 when the acceleration sensor 106 detects the intensity of rocking equal to or more than a certain level. Since the other configurations are similar to those of the apparatus according to Embodiment 1, their descriptions are omitted.

In the apparatus according to Embodiment 1, the fuel 2 is supplied into the pump cup 1 at constant time intervals when the vehicle runs in the stop state of the engine 14. However, if significant rocking occurs during slalom running for example, a large amount of the fuel 2 overflows from the pump cup 1 at a time. In this case, it is conceivable that the fuel 2 inside the pump cup 1 becomes insufficient by simply supplying a predetermined amount of the fuel 2 at constant time intervals.

With this consideration in mind, the apparatus according to Embodiment 2 is provided with the acceleration sensor 106 electrically connected to the ECU 107. The ECU 107 has the function of issuing the control command for automatically driving the fuel pump 3 when the acceleration sensor 106 detects the intensity of rocking equal to or more than a certain level, whereby the fuel 2 is supplied into the pump cup 1. This operation of the ECU 107 does not relate to the above-mentioned time measurement at all. Hence, the control command for supplying the fuel 2 into the pump cup 1 at constant time intervals on the basis of the above-mentioned time measurement is issued regardless of this operation.

Thanks to this setting, in the apparatus according to Embodiment 2, an appropriate amount of the fuel 2 is maintained inside the pump cup 1 even if significant rocking occurs, whereby it is possible to more securely avoid a state in which the fuel 2 is exhausted from the inside of the pump cup 1 at the start time of the engine 14.

### Embodiment 3

An apparatus according to Embodiment 3 of the present invention will be described using FIG. 1. In the apparatuses according to Embodiments 1 and 2, it is assumed that the insufficiency of the fuel inside the pump cup 1 occurs because the fuel 2 overflows from the opening of the pump cup 1 due to rocking. However, rocking is not the only cause of the insufficiency of the fuel inside the pump cup 1. Even during vehicle stop, if the sealing of the one-way valve 5 is incomplete, the fuel 2 inside the pump cup 1 leaks therefrom. Hence, if the vehicle stops for a long time, it is likely that a similar problem will occur.

With this consideration in mind, in the apparatus according to Embodiment 3, the ECU 107 of the apparatus according to Embodiment 1 is further provided with a function of issuing a control command for automatically driving the fuel pump 3 immediately after the power source of the vehicle is turned on, that is, when the state is shifted to the running preparation maintaining state of the vehicle in the engine stop mode so that the fuel 2 is supplied into the pump cup 1.

Thanks to this setting, in the apparatus according to Embodiment 3, even if the fuel 2 leaks from the pump cup 1 when the vehicle stops for a long time, the fuel 2 is supplied into the pump cup 1 at the time of start, whereby it is possible to avoid a state in which the fuel 2 is exhausted from the inside of the pump cup 1 at the start time of the engine 14.

### Embodiment 4

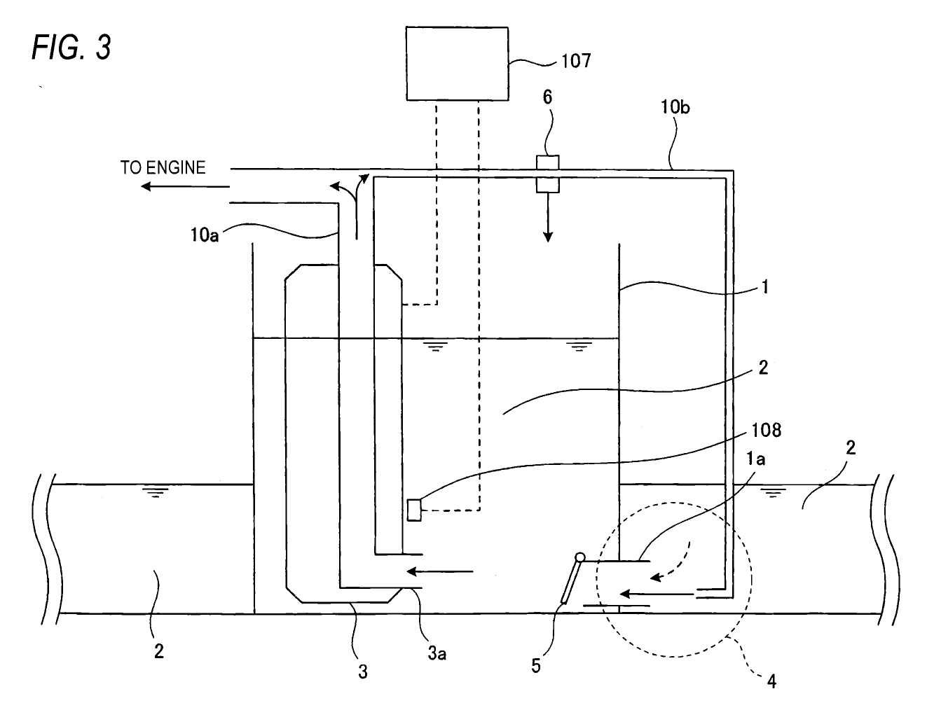

An apparatus according to Embodiment 4 of the present invention will be described using FIG. 3.

In the apparatus according to Embodiment 4, a low-level liquid level sensor (a first liquid level sensor) 108 serving as a liquid level detecting unit and electrically connected to the ECU 107 is disposed above the fuel suction port 3a of the fuel pump 3. If the fuel 2 inside the pump cup 1 overflows due to rocking or the like during running in the stop state of the engine 14 (engine stop mode) and the level of the fuel 2 lowers to the position of the sensor 108, the fuel pump 3 is automatically driven according to a control command of the ECU 107 so that the fuel 2 is supplied into the pump cup 1. Hence, an appropriate amount of the fuel 2 is maintained inside the pump cup, whereby it is possible to avoid a state in which the fuel 2 is exhausted from the inside of the pump cup 1 at the start time of the engine 14.

In the apparatus according to Embodiment 4, the ECU 107 is not always required to have the time measurement function.

It is desired that the position of the low-level liquid level sensor 108 should not be equal to or lower than the position of the fuel suction port 3a of the fuel pump 3 and should not be far away from the fuel suction port 3a of the fuel pump 3 in the horizontal direction.

These are based on the following reasons. If the position of the sensor 108 is equal to or lower than the position of the fuel suction port 3a of the fuel pump 3, a state in which the suction port 3a cannot suck the fuel 2 (a state in which the start of the engine 14 becomes defective) occurs before the liquid level lowers to the height position of the sensor 108. Even if the sensor 108 is disposed so that its position is higher than the position of the fuel suction port 3a of the fuel pump 3, if the position of the sensor 108 is away from the fuel suction port 3a in the horizontal direction, it is likely that the sensor 108 makes no response and the fuel 2 has such a level as not to be sucked at the suction port 3a when the liquid level is inclined by the tilting of the vehicle body 11 or by rocking during running.

Thanks to this setting, in the apparatus according to Embodiment 4, an appropriate amount of the fuel 2 can be maintained inside the pump cup 1.

### Embodiment 5

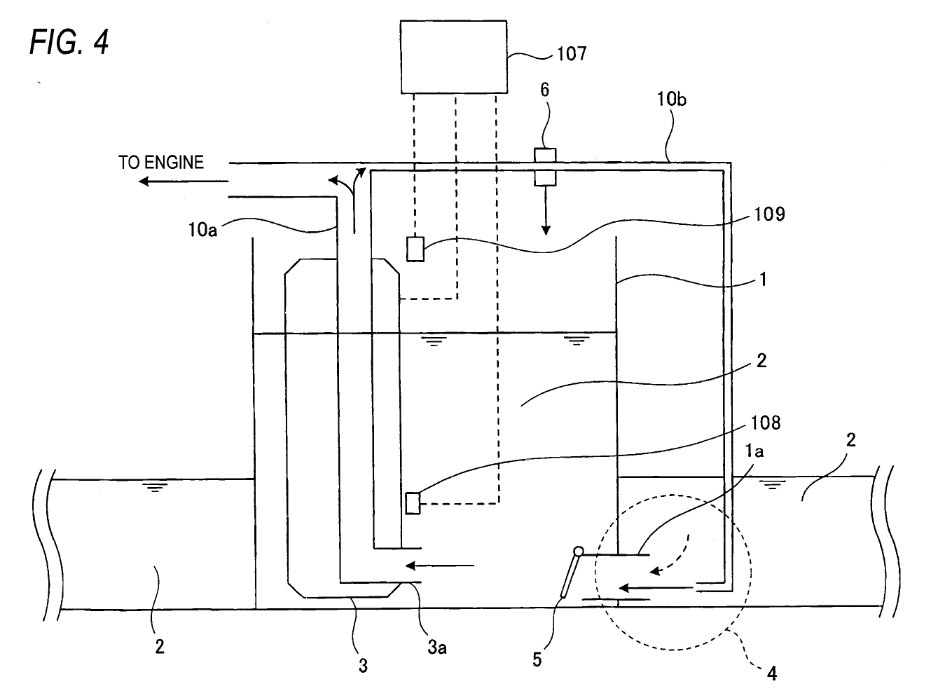

An apparatus according to Embodiment 5 of the present invention will be described using FIG. 4. In the apparatus according to Embodiment 5, in addition to the configuration of the apparatus according to Embodiment 4, a high-level liquid level sensor (a second liquid level sensor) 109 serving as a liquid level sensor is disposed below the opening of the pump cup 1. The sensor 109 is electrically connected to the ECU 107.

As in the case of the apparatus according to Embodiment 4, when the fuel 2 overflows due to rocking during running in the stop state of the engine 14 and the liquid level lowers to the position of the low-level fluid level sensor 108, the fuel pump 3 is driven according to a control command of the ECU 107, and the fuel 2 is supplied into the pump cup 1. However, when the pump cup 1 is nearly filled with the fuel 2 and the level of the fuel 2 rises to the position of the high-level liquid level sensor 109, the fuel pump 3 is stopped automatically according to a control command of the ECU 107.

Hence, the fuel pump 3 is prevented from being driven more than necessary and wasteful battery consumption can be suppressed.

As the high-level liquid level sensor 109 is positioned closer to the height position of the opening of the pump cup 1, the pump cup 1 can be supplied with the fuel 2 more fully, whereby an appropriate amount of the fuel 2 can be maintained inside the pump cup more securely.

According to an aspect of the present invention, fuel is supplied into the pump cup during running in the stop state of the engine, whereby defective starting due to insufficient fuel supply into the engine can be prevented when the engine is started.

According to an aspect of the present invention, a one-way valve is provided to allow fuel to enter the pump cup from the fuel tank, whereby the fuel supplied into the cup can be stored and the liquid level inside the pump cup can be kept high.

According to an aspect of the present invention, one end of the branched pipe faces the communication port, whereby the fuel to be discharged from the branched pipe is easily supplied to the communication port.

According to an aspect of the present invention, the fuel pump can be operated at constant time intervals, whereby the fuel inside the pump cup can be avoided from being exhausted.

According to an of the present invention, fuel is supplied into the pump cup immediately after the power source of the vehicle body is turned on and the vehicle starts to run first time, whereby defective starting due to insufficient fuel supply into the engine can be prevented.

According to an aspect of the present invention, when the intensity of rocking equal to or more than a certain level is detected, fuel is supplied into the pump cup, whereby defective starting due to insufficient fuel supply into the engine can be prevented.

According to an aspect of the present invention, when the liquid level of the fuel inside the pump cup lowers during running in the stop state of the engine, fuel is supplied into the pump cup, whereby defective starting due to insufficient fuel supply into the engine can be prevented.

According to an aspect of the present invention, when the supplied amount of the fuel inside the pump cup has reached an amount in which fuel deficiency cannot be avoided, the operation of the fuel pump is started, whereby the fuel pump is prevented from being driven more than necessary and wasteful battery consumption can be suppressed.

According to an aspect of the present invention, when the fuel supply amount inside the pump cup has reached a certain amount, the fuel pump is stopped, whereby the fuel pump is prevented from being driven more than necessary and wasteful battery consumption can be suppressed.

The present invention is preferable as a fuel tank apparatus mounted on a hybrid vehicle that can run using an engine and a motor driven independently of each other.

What is claimed is:

1. A fuel tank apparatus mounted on a hybrid vehicle capable of being switched between an engine drive mode in which vehicle running using an engine is performed or power generation using the engine is performed, in an engine drive state in which fuel supply to the engine is performed, and an engine stop mode in which vehicle running using an electric motor is performed or a running preparation state is maintained, in an engine stop state in which fuel supply to the engine is shut off, the fuel tank apparatus comprising:
a fuel supply pipe, which extends from a fuel tank body and one end of which is connected to the engine, for fuel supply to the engine;
a fuel supply shut-off unit which configured to allow fuel supply to the engine from the fuel supply pipe in the engine drive state and which configured to shut off fuel supply to the engine in the engine stop state;
a cup which is disposed inside the fuel tank body and which includes a communication port which communicates with inside and outside of the cup and through which fuel is allowed to enter the cup, the cup which is configured to temporarily store fuel to be allowed to enter the fuel supply pipe;
a fuel pump which is configured to operate to supply fuel stored in the cup to the fuel supply pipe and to generate negative pressure inside the cup to allow fuel to enter the inside of the cup through the communication port; and
a fuel pump controlling unit which is configured to control the operation of the fuel pump,
the fuel pump controlling unit which is configured to operate the fuel pump to perform fuel supply to the engine and to allow fuel to enter the inside of the cup, in the engine drive mode,
the fuel pump controlling unit which is configured to operate the fuel pump to allow fuel to enter the inside of the cup although fuel supply to the engine is shut off by the fuel supply shut-off unit, in the engine stop mode.

2. The fuel tank apparatus according to claim 1, wherein, in the engine stop mode, the fuel pump controlling unit operates the fuel pump for a time to allow fuel to enter the inside of the cup although fuel supply to the engine is shut off by the fuel supply shut-off unit.

3. The fuel tank apparatus according to claim 2, wherein, a one-way valve that is opened by the negative pressure generated inside the cup when the fuel pump is operated to allow fuel to enter the cup from the fuel tank body is disposed at the communication port.

4. The fuel tank apparatus according to claim 2, further comprising a branched pipe which is branched from the fuel supply pipe to discharge fuel inside the cup to the outside of the cup from the fuel supply pipe, one end of the branched pipe outside the cup being positioned so as to face the communication port.

5. The fuel tank apparatus according to claim 2, wherein the fuel pump controlling unit performs timer-based repetitive operation to operate the fuel pump repeatedly.

6. The fuel tank apparatus according to claim 5, wherein the fuel pump controlling unit performs a first cycle of the timer-based repetitive operation when a power source of the hybrid vehicle is turned on in the engine stop mode and a state of the hybrid vehicle is shifted to the running preparation state.

7. The fuel tank apparatus according to claim 2, further comprising an acceleration detecting unit which is configured to detect an acceleration of the vehicle, wherein the fuel pump controlling unit forcibly operates the fuel pump for a time depending on the acceleration detected by the acceleration detecting unit.

8. The fuel tank apparatus according to claim 1, further comprising a liquid level detecting unit which is configured to detect a liquid level of fuel stored inside the cup, wherein
in the engine stop mode, the fuel pump controlling unit operates the fuel pump, depending on a value of the liquid level detected by the liquid level detecting unit, to allow fuel to enter the inside of the cup although fuel supply to the engine is shut off by the fuel supply shut-off unit.

9. The fuel tank apparatus according to claim 8, wherein a one-way valve that is opened by the negative pressure generated inside the cup when the fuel pump is operated to allow fuel to enter the cup from the fuel tank body is disposed at the communication port.

10. The fuel tank apparatus according to claim 8, further comprising a branched pipe which is branched from the fuel supply pipe to discharge fuel inside the cup to the outside of the cup from the fuel supply pipe, one end of the branched pipe outside the cup being positioned so as to face the communication port.

11. The fuel tank apparatus according to claim 8, wherein
the liquid level detecting unit includes a first liquid level sensor disposed above the other end of the fuel supply pipe positioned inside the cup, and
the fuel pump controlling unit operates the fuel pump when the liquid level of fuel stored inside the cup lowers to a position below the first liquid level sensor.

12. The fuel tank apparatus according to claim 11, wherein
the liquid level detecting unit further includes a second liquid level sensor disposed above the first liquid level sensor, and
the fuel pump controlling unit starts the operation of the fuel pump when the liquid level of fuel stored inside the cup lowers to a position below the first liquid level sensor, continues the operation of the fuel pump until the liquid level of fuel rises to a position of the second liquid level sensor, and stops the operation of the fuel pump when the liquid level of fuel rises to a position above the first liquid level sensor.
